(19) United States
(12) Patent Application Publication
(10) Pub. No.: US 2008/0142464 A1
(43) Pub. Date: Jun. 19, 2008

(54) Supporting Bracket for Mobile Machine Tools

(76) Inventor: Dietmar Fugel, Wolfschlugen (DE)

Correspondence Address: COLLARD & ROE, P.C., 1077 NORTHERN BOULEVARD, ROSLYN, NY, 11576, US

(21) Appl. No.: 11/884,248

(22) PCT Filed: Jan. 21, 2006
(86) PCT No.: PCT/EP2006/000532

§ 371 Date: Aug. 13, 2007

(30) Foreign Application Priority Data
Feb. 17, 2005 (DE) 10 2005 007 522.3

(51) Int. Cl. B66C 17/04

(52) U.S. Cl. 212/349; 212/180

(57) ABSTRACT

The invention relates to a supporting bracket (38) of a supporting construction for mobile machine tools, especially for concrete pumps. The supporting bracket (38) is multi-telescopic and comprises a carriage (38) which is pivotably arranged on the chassis (10), and a telescopic part consisting of a plurality of telescopic segments (40′, 40″, 40′″) which are guided inside each other, engage in the carriage, and are mobile in relation thereto. The aim of the invention is to provide a narrow support using simple means. To this end, the carriage (38) and at least some of the telescopic segments (40″, 40′″) have coupling points (50′, 50″, 50′″) on which the segments can be coupled in pairs in such a way as to produce a fixed connection when the segments are retracted in relation to each other.

The invention relates to a support boom for mobile work machines, particularly for mobile concrete pumps, having a push-out box disposed on a chassis, preferably so as to pivot, having a telescope part consisting of several telescope segments guided inside one another, which engages into the push-out box, and having a foot part disposed on the front end of the first telescope segment, preferably adjustable vertically.

In the case of mobile concrete pumps, it is known (DE-A-10032622) to configure at least one part of the support boom as a multiple telescope, which engages into a push-out box that can pivot relative to the chassis and is displaceable relative to the latter. In the operating state, the telescope segments are always completely extended there. A narrow support on construction sites that have limited space is brought about in that the set-up angle of the support boom relative to the chassis is reduced in size.

Proceeding from this, the invention is based on the task of improving the known support booms of the type indicated initially in such a manner that a further possibility of narrow support is obtained, which can be adjusted in simple and reliable manner during the set-up process.

To accomplish this task, the combination of characteristics indicated in claim 1 is proposed. Advantageous embodiments and further developments are evident from the dependent claims.

The solution according to the invention is based on the thought that during the set-up process, only part of the telescope segments is extended, and the other segments remain in their retracted position. In order to ensure, in the case of such set-up, that individual telescope segments do not get into a mechanically unstable position in which they are only partly extended, it is proposed, according to the invention, that the push-out box and at least part of the telescope segments have coupling points at which they can be coupled with one another, in pairs, in the state in which they are retracted, relative to one another, producing a connection that is resistant to displacement. With this measure, the result is achieved that during the set-up process, individual telescope segments are either extended completely or remain completely in their retracted position.

A preferred embodiment of the invention provides that the coupling points are disposed in the region of the front end of the push-out box and at least of a part of the telescope segments. It is practical if the coupling points have a defined distance from one another in the retracted state of the telescope segments, so that a coupling organ can be used for connecting them, which organ is configured in such a manner that it can be coupled with two selected coupling points, in each instance, producing the connection that is resistant to displacement.

Another preferred structural embodiment of the invention provides that coupling pins are disposed at the coupling points, which have a defined distance from one another in the retracted state of the telescope segments, in pairs, and that the coupling organ has the shape of a tab having two recesses disposed at the distance of the coupling pins from one another, for being set onto selected coupling pins.

In order to be able to accommodate the coupling organ so that it cannot come loose, even when it is not in use, it is practical if the push-out box has another holder pin for the coupling organ, which pin is disposed at a defined distance from the related coupling pin. The coupling and holder pins can have a crosswise bore for accommodating a locking element, preferably configured as a spring plug.

In the following, the invention will be explained in greater detail using an exemplary embodiment shown schematically in the drawing. This shows:

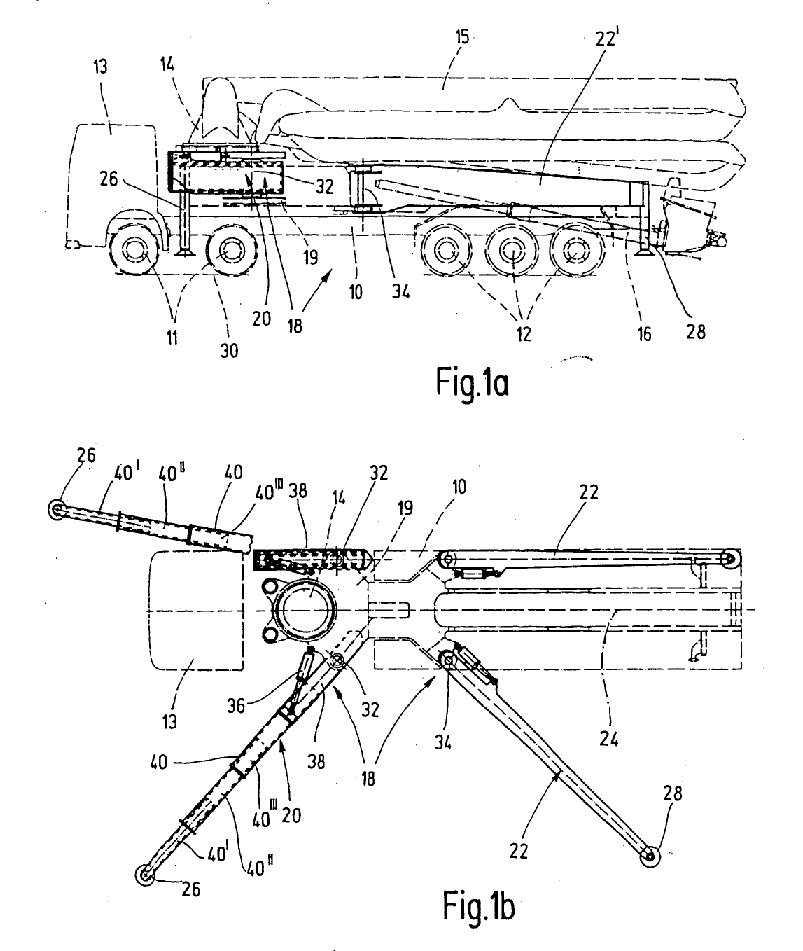

FIG. 1a a side view of a mobile concrete pump with support booms in the transport position;

FIG. 1b a top view of the mobile concrete pump with support booms in various positions;

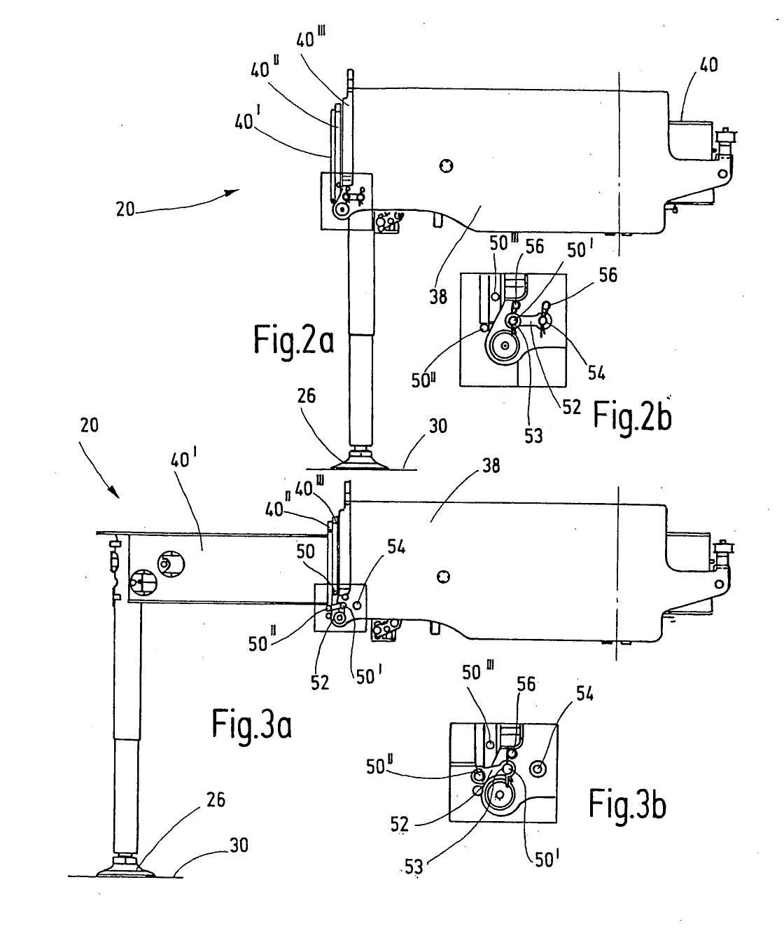

FIGS. 2a and b, a side view of a front support boom in the retracted state, as well as an enlarged detail of the coupling region;

FIGS. 3a and b, a side view of the support boom with the first telescope segment extended, as well as an enlarged detail of the coupling region;

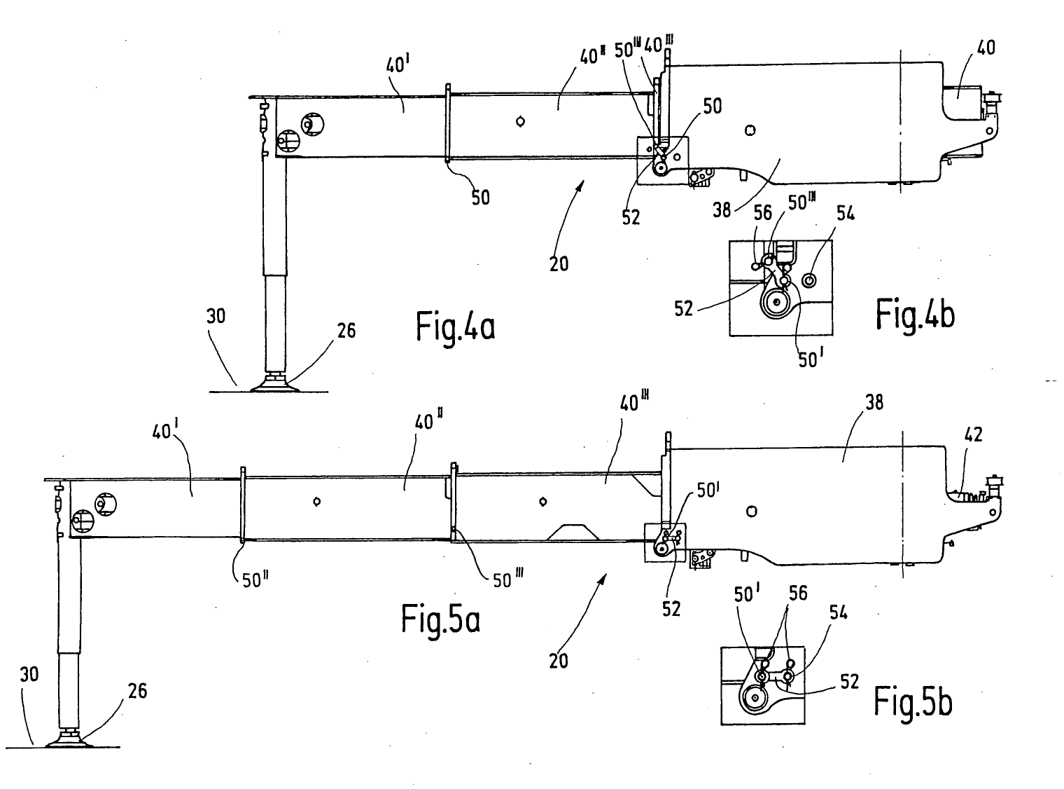

FIGS. 4a and b, a side view of the support boom with the first and second support boom extended, as well as an enlarged detail of the coupling region;

FIGS. 5a and b, a side view of the support boom with the telescope segments completely extended, as well as an enlarged detail of the coupling region.

The mobile concrete pump shown in FIGS. 1a and b essentially consists of a multi-axle chassis 10 having two front axles 11 and three rear axles 12, having a driver's cabin 13, a concrete distributor mast 15 mounted on a rotation mechanism 14 close to the front axle, so as to rotate about a vertical axis, having a pump arrangement 16 mounted on the chassis 10 at a distance from the rotation mechanism 14, as well as a support construction 18 for the chassis 10. The support construction 18 has a support frame 19 fixed to the chassis, and comprises two front support booms 20 and two rear support booms 22, which are drawn in, in the transport position, and oriented parallel to the longitudinal axis 24 of the vehicle, and, in the support position, project beyond the chassis 10 to the front and to the rear, respectively, and are supported on the ground 30 with their foot parts 26, 28.

The front support booms 20 can be pivoted about their vertical pivot axles 32, and the rear support booms 22 can be pivoted about their vertical pivot axles 34, between the transport position and the support position, under the effect of a set-up cylinder 36, in each instance.

The front support booms 20 are configured as telescope booms. They comprise a push-out box 38 that can pivot relative to the chassis, about the vertical pivot axle 32, in each instance, and a telescope part 40 consisting of three telescope segments 40′, 40″, 40′″. A dual-action hydro-cylinder 42 that can telescope multiple times extends through the push-out box 38 and the telescope part 40.

A particular feature of the telescoping support boom 20 consists in the fact that the telescope segments 40′, 40″, 40′″ can be extended to a stop, also individually (cf. FIG. 3a to 5a). For this purpose, the push-out box 38 and the two telescope segments 40″, 40′″ have a coupling point configured as coupling pins 50′, 50″, 50′″, in each instance, at which they can be coupled with one another, in pairs, in the state in which they are retracted relative to one another, producing a displaceable connection (FIGS. 3b and 4b). Coupling takes place using a tab-shaped coupling organ 52 that has two recesses 53 disposed at a distance from one another, and that can be coupled with two selected coupling pins 50′, 50″ or 50′, 50′″, in each instance, producing a connection that is resistant to displacement.

Another holder pin 54 on the push-out box ensures that the coupling organ can be fixed in place on the push-out box so as not to come loose, when it is not in use. The coupling pins 50′, 50″, 50′″ furthermore have a cross-bore into which a locking element configured as a spring plug 56 can be inserted, to secure the coupling organ 52. In the positions shown in FIGS. 2a and b, as well as 5a and b, the coupling organ is in its holding position, in which it has no function, and in which it is held so as not to come loose. In this position of the coupling organ, the telescope segments 40′, 40″, 40′″ can be displaced from the retracted end position shown in FIGS. 2a and b into the completely extended end position shown in FIGS. 5a and b.

In the state of FIGS. 3a and b, the coupling organ 52 extends between the coupling pin 50′ on the push-out box and 50″ at the free end of the second telescope segment 40″. Accordingly, in this state, only the first telescope segment 50′ can be extended, while the telescope segments 50″ and 50′″ are held in place in their retracted position.

In the case of the arrangement shown in FIGS. 4a and b, in which the coupling organ 52 extends between the coupling pins 50′ and 50′″, the two telescope segments 40′ and 40″ can be extended, while the telescope segment 40′″ is held in place in its retracted position, by way of the coupling organ 52.

The coupling organs 52 are set onto the coupling pins by the pump driver, as needed, before the support booms are extended, in one of the selected positions. In this way, it is possible to set one of the three extension positions for the subsequent extension process, as shown in FIGS. 3a, 4a, and 5a, in simple and reliable manner. Undesirable intermediate positions of the telescope booms are precluded. Fundamentally, it would also be possible to affix the coupling organ between the two coupling pins 50″, 50′″. In this case, only the first and the third telescope segments 40′, 40′″ can be extended during the extension process, while the second telescope segment 40″ would remain in its retracted position within the third telescope segment 40′″.

In summary, the following should be stated: The invention relates to a support boom 38 of a support construction for mobile work machines, particularly for mobile concrete pumps. The support boom 38 can telescope multiple times and has a push-out box 38 that is disposed so as to pivot on the chassis 10, as well as a telescope part that consists of several telescope segments 40′, 40″, 40′″ that are guided in one another, which part engages into the push-out box and is displaceable relative to the latter.

In order to be able to bring about narrow support with simple means, the push-out box 38 and at least part of the telescope segments 40″, 40′″ have coupling points 50′, 50″, 50′″ at which they can be coupled with one another, in pairs, in the state in which they are retracted relative to one another, producing a connection that is resistant to displacement.

1-9. (canceled)

10. Support boom for mobile work machines, having a push-out box (38) disposed on a chassis (10), having a telescope part (40) consisting of several telescope segments (40′, 40″, 40′″) guided inside one another, which engages into the push-out box (38), and is displaceable relative to the latter, and having a foot part (26) disposed on the front end of the first telescope segment (40′), preferably adjustable vertically, wherein the push-out box (38) and at least part of the telescope segments (40″, 40′″) have coupling points (50′, 50″, 50′″) at which they can be coupled with one another, in pairs, in the state in which they are retracted, relative to one another, producing a connection that is resistant to displacement, wherein coupling pins are disposed at the coupling points (50′, 50″, 50′″), which pins have a defined distance from one another in the retracted state of the telescope segments, in pairs, and that the coupling organ (52) has two recesses (53) disposed at the distance of the coupling pins from one another, for being set onto selected coupling pins.

11. Support boom according to claim 10, wherein the coupling points (50′, 50″, 50′″) are disposed in the region of the front end of the push-out box (38) and at least of a part of the telescope segments (40″, 40′″).

12. Support boom according to claim 10, wherein the coupling points (50′, 50″, 50′″) have a defined distance from one another in the retracted state of the telescope segments (40″, 40′″).

13. Support boom according to claim 10, whereby a coupling organ (52) that is configured in such a manner that it can be coupled with two selected coupling points (50′, 50″, 50′″), in each instance, producing the connection that is resistant to displacement.

14. Support boom according to claim 10, wherein the push-out box (38) has a holder pin (54) for the coupling organ (52), which pin is disposed at a defined distance from the coupling pin (50′) on the push-out box side.

15. Support boom according to claim 10, wherein the coupling pins (50′, 50″, 50′″) have a crosswise bore for accommodating a locking element, preferably configured as a spring plug (56).

16. Support boom according to claim 10, wherein the coupling organ has the shape of a tab having two recesses (53) disposed at a distance from one another.

17. Support construction for work machines, particularly for mobile concrete pumps, whereby at least two support booms according to claim 10.

18. Work machine, particularly mobile concrete pump, whereby a support construction according to claim 17.
